(19) United States
(12) Patent Application Publication
(10) Pub. No.: US 2010/0158646 A1
(43) Pub. Date: Jun. 24, 2010

(54) Method and Apparatus for Handling Magnetic Particles

(75) Inventors: Surya Utama Shandy, College Station, TX (US); Sze-Shun Season Wong, College Station, TX (US)

Correspondence Address: STREETS & STEELE, 13100 WORTHAM CENTER DRIVE, SUITE 245, HOUSTON, TX, 77065, US

(73) Assignee: LYNNTECH, INC., College Station, TX (US)

(21) Appl. No.: 12/642,899

(22) Filed: Dec. 21, 2009

Related U.S. Application Data
(60) Provisional application No. 61/140,125, filed on Dec. 23, 2008.

(51) Int. Cl. B65G 49/00; F04D 13/06

(52) U.S. Cl. 414/222.13; 414/222.01; 417/423.1

(57) ABSTRACT

Method, apparatus and system for controllably conveying magnetic particles between closed chambers. Magnetic particles are magnetically attracted from a first solution-containing chamber into a motive cavity, such as may be formed in a rotor of a pump. The magnetic particle-containing motive cavity is then moved out of fluid communication with the first solution-filled chamber and moved into fluid communication with a second solution-filled chamber. Finally, the magnetic particles are magnetically releasing from the motive cavity into the second solution-containing chamber. The first and second chambers are preferably never in direct fluid communication. Because the rotor is sealed with the pump body and there is no direct fluid communication between the first and second chamber, contact between the first solution and the second solution is limited by the size of the motive cavity. Optionally, the particles are magnetically attracted by temporarily inserting a magnet into a rotor. This method has significant advantages over existing magnetic particle manipulation systems because it can be utilized as a closed system with a very innovative and low-cost approach.

### CROSS-REFERENCE TO RELATED APPLICATIONS

This application claims priority of U.S. provisional patent application 61/140,125 filed on Dec. 23, 2008.

### BACKGROUND OF THE INVENTION

1. Field of the Invention

The present invention relates to the handling of magnetic particles.

2. Background of the Related Art

Nucleic acid (NA) based analysis in molecular-based assays relies heavily on the success of the extraction of NA from complex sample matrices regardless of whether the detection is done in the laboratory or in the field. The upstream sample preparation steps have to effectively lyse cells, recover NA, and purify NA by removing interfering contaminants from samples. The samples may possess numerous contaminants (PCR interfering or inhibiting components) depending on the sample type. For example, the extraction of human genomic DNA from tissue samples may be contaminated with communal bacterial flora. On the contrary, for infectious disease diagnostics, the complex environment of human blood hinders the detection of infection because of the presence of red blood cells, white blood cells, transient contaminant bacteria, and numerous components of the immune system. For environmental analysis, sample preparation is needed for likely-contaminated environmental fluids. In addition, since both the pathogen range and the number of different sample types are expanding and because multiplexed downstream testing is becoming standard practice, there is a need for a generic extraction method. Ideally, the NA extraction procedure should yield high quality NA from different pathogens and from a broad range of sample types that are free from interferences for downstream applications.

In short, the techniques used in cell lysis, NA recovery, and NA purification for sample preparation are vital to the success of downstream applications. The overall sensitivity of the assay is determined by the NA yield, its purity, and the amount of sample equivalents that can be transferred into the downstream amplification reaction.

Nucleic acid amplification techniques are being incorporated more and more into clinical laboratories due to the high sensitivity and specificity of these assays. Advances in these techniques, including implementation of real-time PCR, have significantly shortened the test turnaround time, which has significantly improved patient care for some immediately needed tests. While molecular diagnostics has been implemented in many centralized laboratory settings, their uses in non-traditional health care settings (away from centralized laboratories) have been very limited. In non-traditional settings where resources are usually lacking, manual sample preparation methods can be utilized but they are mostly labor intensive and susceptible to contamination, handling variations, or errors. The lack of low-cost devices for high performance and consistent sample preparation is one of the primary limiting factors in adapting diagnostic tests to non-traditional settings.

### BRIEF SUMMARY OF THE INVENTION

One embodiment of the present invention provides a method of controllably conveying magnetic particles between closed chambers. According to the method, magnetic particles are magnetically attracted from a first solution-containing chamber into a motive cavity. The magnetic particle-containing motive cavity is then moved out of fluid communication with the first solution-filled chamber and moved into fluid communication with a second solution-filled chamber. Finally, the magnetic particles are magnetically released from the motive cavity into the second solution-containing chamber. The first and second chambers are preferably never in direct fluid communication.

Another embodiment of the invention provides an apparatus comprising first and second chambers and a rotary pump disposed between the first and second chambers. The rotary pump has a body and a rotor, and the body includes a first port to the first chamber, a second port to the second chamber, and a seat. The rotor is in sealed contact with the seat to prevent direct fluid communication between the first and second chambers and includes an outwardly facing cavity and an internal opening for receiving a magnet adjacent the cavity. A manual or automated rotary actuator allows rotation of the rotor within the seat from a first position with the cavity facing the first port to a second position with the cavity facing the second port. A magnet may be manually inserted and removed from the internal opening in the rotor. Alternatively, the apparatus may include a magnet that is aligned with the internal opening and an actuator, such as a step-motor, for moving the magnet in and out of the internal opening.

A further embodiment provides a diagnostic system comprising a plurality of fluid-tight chambers interconnected by rotary pumps. Each rotary pump has a body and a rotor, wherein the body includes a first port to a first chamber, a second port to a second chamber, and a seat. The rotor is in sealed contact with the seat to prevent direct fluid communication between the first and second chambers and includes an outwardly facing cavity and an internal opening for receiving a magnet adjacent the cavity. The rotor is also rotatable within the seat from a first position with the cavity facing the first port to a second position with the cavity facing the second port. Other elements or components of the previously described apparatus may also be included in the diagnostic system.

### BRIEF DESCRIPTION OF THE SEVERAL VIEWS OF THE DRAWINGS

FIGS. 1A-D are schematic side views of two solution-filled chambers separated by a magnetic particle transfer pump.

FIG. 2 is an exploded perspective view of the particle transfer pump, showing the rotor axially separated from the pump body.

FIG. 3 is a perspective view of a series of chambers separated by magnetic particle transfer pumps.

FIG. 4 is a schematic diagram of a miniaturized laboratory module that implements a process based on the use of magnetic particles.

FIG. 5 is a diagram of an automated magnetic particle transfer pump.

FIG. 6 is a schematic perspective view of a system that includes four laboratory modules.

FIGS. 7A-D are schematic top views of a second embodiment of a magnetic particle transfer pump that includes a magnetic force shield.

### DETAILED DESCRIPTION OF THE INVENTION

One embodiment of the present invention provides a method of controllably conveying magnetic particles between closed chambers. According to the method, magnetic particles are magnetically attracted from a first solution-containing chamber into a motive cavity. The magnetic particle-containing motive cavity is then moved out of fluid communication with the first solution-filled chamber and moved into fluid communication with a second solution-filled chamber. Finally, the magnetic particles are magnetically released from the motive cavity into the second solution-containing chamber. The first and second chambers are preferably never in direct fluid communication.

In another embodiment, the motive cavity is formed in the rotor of a rotary pump. Accordingly, the steps of moving the magnetic particle-containing motive cavity out of fluid communication with the first solution-filled chamber and into fluid communication with a second solution-filled chamber may be performed by rotating the rotor. Preferably, the motive cavity is an outwardly facing and concave. Because the rotor is sealed with the pump body and there is no direct fluid communication between the first and second chamber, contact between the first solution and the second solution is limited by the size of the motive cavity. Specifically, the motive cavity is provided with a sufficient capacity to receive the magnetic particles, but solution may fill the interstices around the particles and any excess capacity of the motive cavity.

In yet another embodiment, the step of magnetically attracting magnetic particles includes inserting a magnet into the rotor, and the step of magnetically releasing magnetic particles includes retracting the magnet from the rotor. Movement of the magnet, whether inserting or retracting, may be performed manually or with some degree of automation, such as by coupling the magnet to a step-motor.

In a further embodiment, the magnet is an electromagnet and the step of magnetically attracting includes passing electrical current through an electromagnet. It should be recognized that, unlike a permanent magnet, an electromagnet may be switched on and off. Therefore, the magnetic attraction of an electromagnet may be electronically controlled, such that there is little or no need to physically insert and retract an electromagnet from the pump.

In a still further embodiment, the step of magnetically attracting magnetic particles includes rotating a magnetic force shield within the rotor to a position that does not block the path between the cavity and a magnet positioned within the rotor. Such a shield may be made from any known shielding material, such as nickel and its alloys. Similarly, the step of magnetically releasing magnetic particles may include rotating the magnetic force shield to a position that blocks the path between the cavity and the magnet.

Optionally, the magnetic particles are moved through a sequence of chambers using a rotary pump between each pair of adjacent chambers in the sequence. The sequence of chambers of pumps may form a miniaturized laboratory module in which the sequence of chambers each contain a specific solution to collectively and sequentially perform a process. For example, each chamber may contain a different solution for performing a different step in a process. Conveyance of the magnetic particles through any one or more of the solution-filled chambers is controlled by the rotary pump. An advantage of rotary pump is the ability to convey the magnetic particles without exposing the particles or the solutions to the surrounding environment. In other words, the rotary pump may be operated in a sealed system.

In a further embodiment, the method may include magnetically attracting the magnetic particles into a chamber. Although each rotary pump relies upon the use of a magnet to attract the magnetic particles into its motive cavity, a magnet may also be used in an adjacent rotary pump to draw the magnetic particles out of the cavity (i.e., magnetically releasing the particles) and into solution. In a further option, a magnet may be alternatingly inserted into rotary pumps on either side of solution-filled chamber to move magnetic particles back and forth within the solution.

One embodiment provides an apparatus comprising first and second chambers and a rotary pump disposed between the first and second chambers. The rotary pump has a body and a rotor, and the body includes a first port to the first chamber, a second port to the second chamber, and a seat. The rotor is in sealed contact with the seat to prevent direct fluid communication between the first and second chambers and includes an outwardly facing cavity and an internal opening for receiving a magnet adjacent the cavity. A manual or automated rotary actuator allows rotation of the rotor within the seat from a first position with the cavity facing the first port to a second position with the cavity facing the second port. A magnet may be manually inserted and removed from the internal opening in the rotor. Alternatively, the apparatus may include a magnet that is aligned with the internal opening and an actuator, such as a step-motor, for moving the magnet in and out of the internal opening.

Optionally, the apparatus may be provided with magnetic particles already disposed in one or more chamber. Similarly, the apparatus may be provided with each chamber already filled with a solution for performing a process.

The magnetic particles preferably have a surface that receives and supports a component that interacts with the solution. For example, antibodies may be immobilized of the surface of the particles for the purpose of being carried through the solutions that filled the chambers. Depending upon the nature of the immobilized component, the solutions and the process being carried out, the chambers may be closed to the surrounding atmosphere.

A further embodiment provides a diagnostic system comprising a plurality of fluid-tight chambers interconnected by rotary pumps. Each rotary pump has a body and a rotor, wherein the body includes a first port to a first chamber, a second port to a second chamber, and a seat. The rotor is in sealed contact with the seat to prevent direct fluid communication between the first and second chambers and includes an outwardly facing cavity and an internal opening for receiving a magnet adjacent the cavity. The rotor is also rotatable within the seat from a first position with the cavity facing the first port to a second position with the cavity facing the second port. Other elements or components of the previously described apparatus may also be included in the diagnostic system.

A magnet is an object that produces a magnetic field that pulls on other magnetic materials and attracts or repels other magnets. Magnets are generally classified as either permanent magnets that stay magnetized or electromagnets that act as a magnet when an electric current passes through a coil of wire. Magnetic materials include ferromagnetic materials, such as iron, nickel, cobalt and some rare earth metals and some of their alloys, as well as some naturally occurring minerals such as lodestone. As used herein, the term “magnetic material” specifically includes ferromagnetic materials, but specifically excludes both paramagnetic materials, such as aluminum and oxygen, and diamagnetic materials, such as carbon and water.

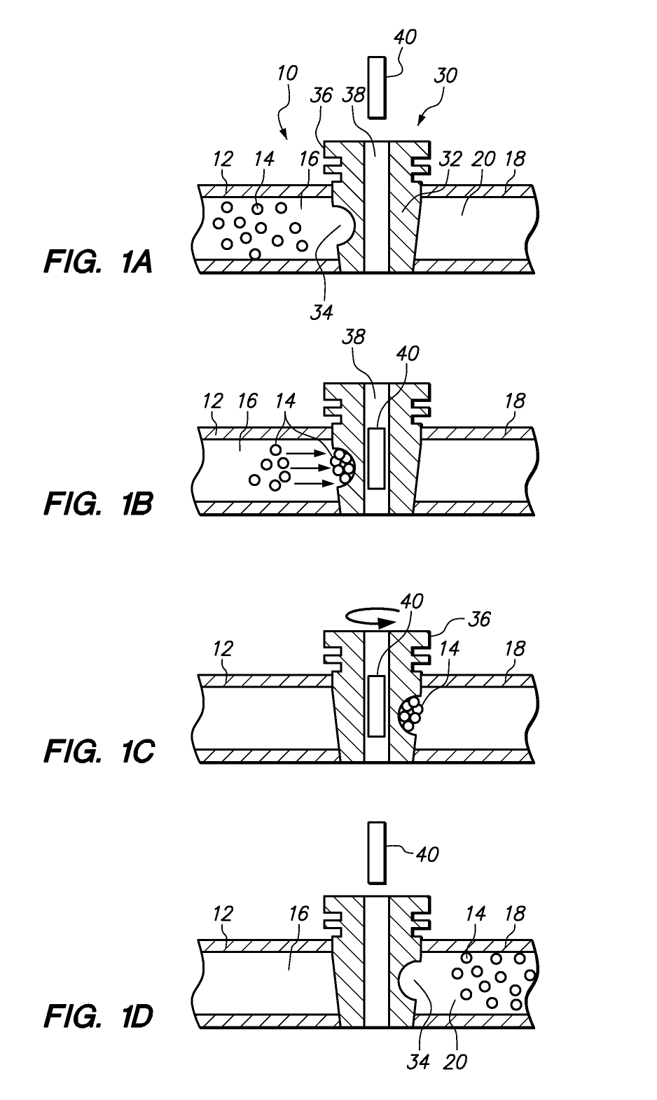

FIGS. 1A-D are schematic side views of two solution-filled chambers separated by a magnetic particle transfer pump. The apparatus 10 includes a first solution-filled chamber 12 having magnetic particles 14 (such as DYNABEADS, available from Invitrogen Corporation of Carlsbad, Calif.) in intimate contact with a first solution 16. A second chamber 18 is filled with a second solution 20. The first and second chambers are separated by a rotary pump 30. Although FIGS. 1A-D are schematic, the view of pump 30 shows the rotor 32, the motive cavity 34, an actuator handle or knob 36, and an opening 38 for selectively receiving a magnet 40.

FIGS. 1A-D illustrate a four-step process of conveying magnetic particles 14 from the first chamber 12 to the second chamber 18. In FIG. 1A, the magnetic particles 14 are in intimate contact with the first solution 16. In FIG. 1B, the magnet 40 has been inserted into the opening 38 in the rotor 32 such that the magnetic particles 14 are magnetically attracted toward the magnet. As a result, the magnetic particles 14 are collected in the motive cavity 34. In FIG. 1C, the actuator knob 36 has been turned 180 degrees so that the motive cavity 34 now faces the second chamber 18. Retracting the magnet 40 as shown in FIG. 1D, releases the magnetic particles into the solution 20. It should be recognized that the chambers 12, 18 may be sealed during the foregoing process and that only a minor amount of the first solution 16 is carried over into the second solution 20 by the motive cavity 34.

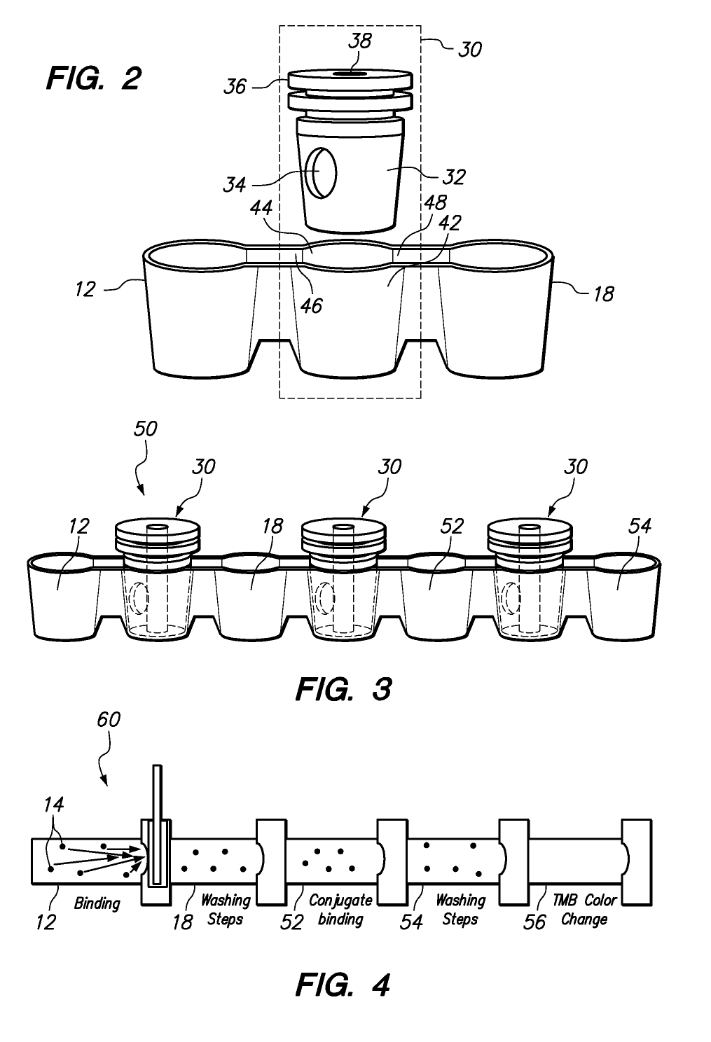

FIG. 2 is an exploded perspective view of the particle transfer pump 30, showing the rotor 32 axially separated from the pump body 42. The pump body 42 is integrated with the opposing chambers 12, 18 and includes a seat 44, a first port 46 directed toward the first chamber 12, and a second port 48 directed toward the second chamber 18. The seat 44 is shaped to receive the rotor 32 and form a fluid-tight seal between the seat and the rotor. Coatings or gaskets are generally not necessary, especially if the seat and rotor are made with suitably small dimensional tolerances from suitable plastic materials. Since the solutions used in the chambers 12, 18 are not pressurized, a fluid-tight seal is generally not difficult to achieve.

The rotor 32 has a motive cavity 34 that faces outwardly for selective alignment with the first port 46, the second port 48, or even the walls of the seat 44. As shown, the rotor 32 may be turned clockwise or counter-clockwise without restriction by turning the knob 36, which extends outward beyond the pump body 42. The opening 38 extends into the rotor 32 behind the cavity 34, but there is no fluid communication between the opening and the cavity. However, the rotor 32 is generally made from a material that does not prevent a magnetic field from extending from a magnet placed within the opening through the cavity 34 and into the adjacent first chamber 12 and/or second chamber 18.

FIG. 3 is a perspective view of an assembly 50 series of four chambers 12, 18, 52, 54 separated by three magnetic particle transfer pumps 30. Each of the pumps 30 may work identically, but typically operate sequentially so that magnetic particles (not shown) may be sequentially conveyed between the chambers. The assembly 50 may be configured as a miniaturized laboratory module having carefully selected solutions filling the four chambers in order to carry out a process on materials bound to magnetic particles. It should be recognized that the size of individual chambers may be varied for any particular process. Not only can the assembly be easily adapted to accommodate different reagents and volumes, but the length of incubation time and degree of agitation can also be controlled to yield high quality results.

FIG. 4 is a schematic diagram of a miniaturized laboratory module 60 that implements a process based on the use of magnetic particles. The example illustrated is a simplified immunoassay that the capturing medium (antigens) specific to a group of biomolecules (such as toxin from E coli. O157:H7 bacteria) are immobilized on the magnetic particles. The module 60 includes five pre-packaged reagent chambers 12, 18, 52, 54, 56 and five pumps 30. The particular bioprocess illustrated, uses magnetic particles 14 coated with an antigen. In chamber 12, the sample (containing the toxin) is mixed with antigen-coated MPs and the mixture is incubated for a period of time and then the antigen-coated MPs are transported from one chamber (12) to another (18, 52, 54, 56) through the sequential use of magnetic particle capture (insertion of a permanent magnet into the rotor), valve rotation (valve rotated 180°), and particle release (magnet withdrawal). This approach allows all sample manipulations to be performed within the confinement of the chambers in the module 60. As shown, the module 60 implements the process steps of binding the target to the antigens on MPs (chamber 12), a first washing to remove the unbound materials (chamber 18), secondary enzyme-modified antibody conjugate binding (chamber 52), a second washing to remove unbound enzyme-modified antibodies (chamber 18), and TMB color change using a chromogen that changes color in the presence of the enzyme-modified antibodies (chamber 56). After chamber 56, a further pump 30 (to the far right in FIG. 4) allows for the elution of a sample for further processing if necessary. After the process has been completed, any biohazardous waste or reagents used in the process remain enclosed in the module for safe storage or disposal. As shown, the module can be made small, lightweight, and highly portable. The size and volume of the chambers and the pumps are completely flexible for simple adaptation to different types of assays.

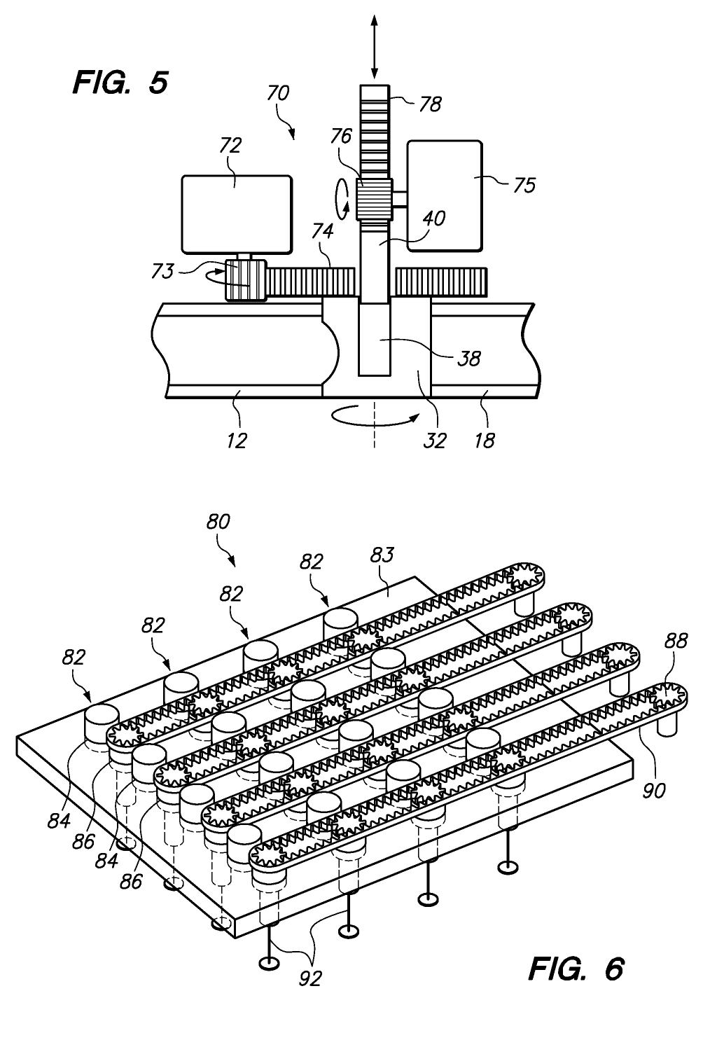

FIG. 5 is a diagram of an automated magnetic particle transfer pump 70. Controllable or programmable step-motors or servos (or any relevant type of actuators) may be used to partially or fully automate operation of the pump. A first servo motor 72 and drive gear 73 controllably rotates a gear 74 coupled to the rotor 32, while a second servo motor 75 and drive gear 76 linearly actuates the magnetic rod assembly 78 to move the magnet 40 in and out of the opening 38. The automated pump 70 may be used to carry out the same pumping action as a manual pump. Optionally, one or more pump 70 may be controlled by a data acquisition system or controller.

FIG. 6 is a schematic perspective view of a system 80 that includes four separate laboratory modules 82. Each module 82 is temporarily secured to a rigid base 83 and includes four process chambers 84 and four pumps 86 for performing a process. A drive gear 88 selectively moves a belt 90 in order to simultaneously actuate the rotor of a first pump in each of the four modules 82. Each rotor has a knob with gear teeth that move with the belt 90. The drive gear 88 may be operated manually or with a motor. At appropriate times for a given process, subsequent drive gears with actual other rows of the pumps. This system is particularly advantageous for processing multiple samples (more than one, ideally 2 to 24) through the same process.

Magnet assemblies 92 are positioned on the opposite side of the pumps from the belts 90 to avoid interference with the belts. A first row of magnet assemblies 92 (corresponding to the first pumps coupled to a first belt 90) may also be simultaneously actuated so that the magnetic particles are handled in the same manner prior to actuating the corresponding pumps. Optionally, the magnet assemblies 92 may operated by a servo motor (such as servo motor 75 and gears 76, 78 as shown in FIG. 5). It should be appreciated that the system 80 may be adapted for use with any number of modules 82 having any number of chambers and pumps. Furthermore, the modules 82 may be removed and replaced with other modules by temporarily disconnecting the belts 90.

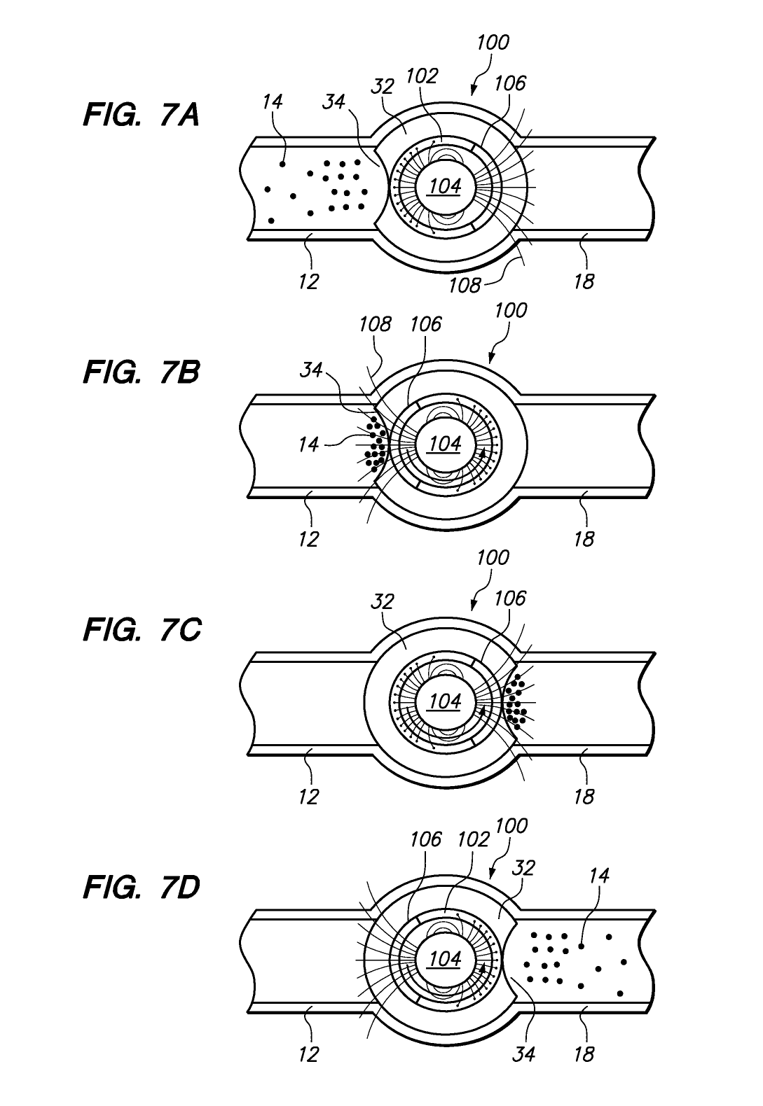

FIGS. 7A-D are schematic top views of a magnetic particle transfer pump 100 that includes a magnetic force shield 102 and a magnet 104 that may remain in the rotor 32. The magnetic force shield 102 may be made from a nickel-containing material and is shown as part of an independently rotatable sleeve 106 inside an axial opening in the rotor 32. The magnet 104 may either rotate with the sleeve 106 and the shield 102, or be rotationally fixed.

In FIG. 7A, the rotor 32 is rotationally positioned so that the motive cavity 34 is in direct communication with the first chamber 12. The sleeve 106 is rotationally positioned so that the shield 102 is positioned behind the cavity 34 to shield the magnetic particles 14 in the first chamber 12 from the magnetic field (see magnetic field lines 108) produced by the magnet 104. Accordingly, the magnetic particles 14 remain within the solution that fills the first chamber 12. In FIG. 7B, the sleeve 106 has been rotated to a position where the shield is no longer disposed between the magnet 104 and the magnetic particles 14. As a result, the magnetic particles 14 are exposed to the magnetic field and attracted into the motive cavity 34. In FIG. 7C, both the rotor 32 and the internal sleeve 106 have been rotated so that the motive cavity is positioned in direct communication with the second chamber 18, yet the magnetic particles 14 remain exposed to the magnetic field and have not been released into the bulk of the solution. In FIG. 7D, the sleeve is rotated 180 degrees to shield the magnetic particles and facilitate their release. Optionally, the position of FIG. 7C may be skipped with the understanding that the magnetic particles 14 will be immediately released into chamber 18 once the rotor is turned so that the cavity 34 is in communication with the chamber 18.

### EXAMPLE 1

### Prototype Magnetic Particle Pump

A polycarbonate stopcock (Cole Parmer 30600-06) was purchased and its plug was modified to become a magnetic particle transfer pump. The modification involved drilling out the valve center using ¼ inch drill bit. This process was done carefully to prevent shredding of the valve because it is made from a soft material. Once the valve was hollowed out, a ¼-inch Teflon rod was inserted into the valve. This Teflon rod blocked the original channel and formed a receptacle to hold the magnetic particles. Once secured, the Teflon rod was made into a hollow tube using a ⅜ inch drill bit. The purpose of the tube is to block the fluid from going through the original hole in the stopcock valve while allowing a magnetic rod to be inserted into and pulled from the plug to actuate the magnetic separation function. The insertion of the magnetic rod efficiently pulls suspended magnetic beads from the adjacent chamber into the cavity. The tube allows a magnetic rod to efficiently pull the magnetic beads from the chamber into the cavity formed by the old port and the custom Teflon tube.

### EXAMPLE 2

### Use of Magnetic Particle Pump to Extract DNA from Bacterial Culture

In this experiment, the pump made in Example 1 was used in a laboratory module to carry out a manual extraction process of nucleic acid from a bacterial culture. The extracted nucleic acid was used for a polymerase chain reaction (PCR) and gel electrophoresis showed the right target band, suggesting that nucleic acid was in fact purified.

Staphylococcus aureus (ATCC # 6538) was placed in Tryptic Soy Broth (TSB) and allowed to incubate at 37° C. until an estimated concentration of 10⁵ CFU/mL was achieved. Next, 200 μL of this bacterial suspension was added to the first chamber of the module. 200 μL of Dynabeads were added to the first chamber and then 20 μL of NaOH was added. The suspension was left to lyse in this chamber for 10 minutes. After 10 minutes had passed a magnet was applied to the pump and the particles were collected in the motive cavity. The pump was turned, releasing the magnetic particles to the second chamber, which was filled with 224 μL 1× Washing Buffer. The beads were allowed to stay in the chamber for 5 minutes and then a magnet was applied to next (third) pump to collect the particles. After the particles were collected, the valve was turned and the particles were released into another (third) chamber which was filled with 225 μL 1× Washing Buffer. The beads were allowed to stay in this chamber for 5 minutes and then a magnet was applied to the next (fourth) pump to collect the particles. The valve was turned, releasing the particles into the last (fourth) chamber, which was filled with 180 μL resuspension buffer. After the application of magnetic field, the magnetic particles were collected and the solution with eluted. Nucleic acid from this chamber was collected and used as the template for PCR.

A control was also run using the same bacterial suspension and the Dynal kit used as per manufacturer instructions. Using a standard plating technique, the concentration of the bacterial suspension was confirmed at 3.18×10⁵ CFU/mL.

A 466-bp fragment of the bacterial 16S ribosome DNA was amplified using the forward primer 16-S F (5′-TCCTAC GGG AGG CAG CAG T-'3) and reverse primer 16-S R (5′-GGA CTA CCA GGG TAT CTA ATC CTG TT-'3). The PCR reaction was set up as follows: 5 μL FB1, 4 μL dNTP's, 1 μL 16-S F, 1 μL 16-S R, 0.25 μL SpeedStar Taq, 37.754, reagent grade water, and 1 μL of extracted template from the valve apparatus. The PCR reaction was conducted using the “takara2step” program on the iCycler and was visualized by agarose gel electrophoresis.

The positive control band from the commercial kit was brighter than the test sample from the present laboratory module, but a very clear product band was present with no streaking or obvious other artifacts in the product. This success of extracting DNA from a gram+ organism indicates that gram− bacteria would be successfully tested as well, due to their weaker cell membrane components.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of conveying magnetic particles between chambers, comprising:
magnetically attracting magnetic particles from a first solution-containing chamber into a motive cavity;
moving the magnetic particle-containing motive cavity out of fluid communication with the first solution-filled chamber;
moving the magnetic particle-containing motive cavity into fluid communication with a second solution-filled chamber; and
magnetically releasing the magnetic particles from the motive cavity into the second solution-containing chamber, wherein the first and second chambers are never in direct fluid communication.

2. The method of claim 1, wherein the motive cavity is formed in the rotor of a rotary pump.

3. The method of claim 2, wherein the steps of moving the magnetic particle-containing motive cavity out of fluid communication with the first solution-filled chamber and moving the magnetic particle-containing motive cavity into fluid communication with a second solution-filled chamber include rotating the rotor.

4. The method of claim 2, wherein the step of magnetically attracting magnetic particles includes inserting a magnet into the rotor.

5. The method of claim 4, wherein the step of magnetically releasing magnetic particles includes retracting the magnet from the rotor.

6. The method of claim 2, wherein the step of magnetically attracting magnetic particles includes rotating a magnetic force shield within the rotor to a position that does not block the path between the cavity and a magnet positioned within the rotor.

7. The method of claim 6, wherein the step of magnetically releasing magnetic particles includes rotating the magnetic force shield to a position that blocks the path between the cavity and the magnet.

8. The method of claim 1, wherein the step of magnetically attracting includes passing electrical current through an electromagnet.

9. The method of claim 1, wherein contact between the first solution and the second solution is limited by the size of the motive cavity.

10. The method of claim 3, wherein the particles are moved through a sequence of chambers using a rotary pump.

11. The method of claim 10, wherein the sequence of chambers each contain a different solution.

12. The method of claim 1, further comprising:
after magnetically releasing the magnetic particles, magnetically attracting the magnetic particles into the second chamber.

13. The method of claim 1, further comprising:
repeating the steps of claim 1 to convey the magnetic particles from the second chamber into a third solution-filled chamber.

14. The method of claim 1, wherein the first and second chambers are sealed from a surrounding environment, and wherein the magnetic particles remain sealed from the surrounding environment as conveyed between the first and second chambers.

15. An apparatus comprising:
first and second chambers;
a rotary pump disposed between the first and second chambers, the rotary pump having a body and a rotor, wherein the body includes a first port to the first chamber, a second port to the second chamber, and a seat, wherein the rotor is in sealed contact with the seat to prevent direct fluid communication between the first and second chambers and includes an outwardly facing cavity and an internal opening for receiving a magnet adjacent the cavity, and wherein the actuator allows rotation of the rotor within the seat from a first position with the cavity facing the first port to a second position with the cavity facing the second port.

16. The apparatus of claim 15, further comprising:
a magnet aligned with the internal opening; and
an actuator for moving the magnet in and out of the internal opening.

17. The apparatus of claim 1, wherein the cavity is concave open in a direction substantially radial to the rotor.

18. The apparatus of claim 15, further comprising:
magnetic particles disposed in the first chamber.

19. The apparatus of claim 18, wherein the magnetic particles have a surface supporting immobilized antibodies.

20. The apparatus of claim 15, further comprising:
an actuator coupled to the rotor for imparting rotation of the rotor.

21. The apparatus of claim 20, wherein the actuator is a manually operated handle.

22. The apparatus of claim 15, wherein the actuator is a step-motor.

23. The apparatus of claim 15, wherein the first and second chambers are closed to the surrounding atmosphere.

24. A diagnostic system, comprising:
a plurality of fluid-tight chambers interconnected by rotary pumps, each rotary pump having a body and a rotor, wherein the body includes a first port to a first chamber, a second port to a second chamber, and a seat, wherein the rotor is in sealed contact with the seat to prevent direct fluid communication between the first and second chambers and includes an outwardly facing cavity and an internal opening for receiving a magnet adjacent the cavity, and wherein the rotor is rotatable within the seat from a first position with the cavity facing the first port to a second position with the cavity facing the second port.

25. The apparatus of claim 24, wherein each rotary pump further comprises a magnet aligned with the internal opening and an actuator for moving the magnet in and out of the internal opening.

26. The apparatus of claim 24, wherein the plurality of fluid-tight chambers are filled with solutions.

27. The apparatus of claim 24, wherein each rotor is coupled to a rotary actuator for rotating the rotor within the seat.

28. The apparatus of claim 24, further comprising:
magnetic particles disposed at least one of the plurality of chambers.

29. The apparatus of claim 28, wherein the magnetic particles have a surface supporting immobilized antibodies.
